(19) United States
(12) Patent Application Publication
(10) Pub. No.: US 2015/0095696 A1
(43) Pub. Date: Apr. 2, 2015

(54) SECOND-LEVEL RAID CACHE SPLICING

(71) Applicant: DataDirect Networks, Inc., Chatsworth, CA (US)

(72) Inventors: Randall L Hess, Colorado Springs, CO (US); R. Brian Schow, Monument, CO (US); Jesse L. Yandell, Colorado Springs, CO (US); James P. Jackson, Colorado Springs, CO (US)

(73) Assignee: DataDirect Networks, Inc., Chatsworth, CA (US)

(21) Appl. No.: 14/039,107

(22) Filed: Sep. 27, 2013

(51) Int. Cl. G06F 11/10

(52) U.S. Cl. CPC G06F 11/108
USPC 714/6.24

(57) ABSTRACT

System and methods for managing I/O write requests of host systems to physical storage. A storage subsystem includes a plurality of storage devices where each storage device is configured to provide data storage. A controller is connected to the plurality of storage devices for executing the I/O write requests from the host systems and is further connected to a plurality of solid state drives in a parity RAID configuration. Non-valid portions of cache lines stored in stripes of the parity RAID configured second level cache are filled with known default values. Upon receiving an I/O write request to write new data to a non-valid portion of a cache line existing in the second level cache, the new data is spliced into the cache line and a new parity value is calculated without reading the known default values saving a read and an XOR operation.

### FIELD

The presented inventions are generally directed to handling Input/Output (I/O) requests of host systems at physical storage subsystems. More specifically, the presented inventions relate to utilization of second-level cache of solid state drives (SSDs) in a parity RAID configuration that reduces the write costs previously associated with parity RAID configurations.

### BACKGROUND

Large storage systems typically include storage elements that include multiple individual storage devices (e.g., disk drives). The individual storage devices are accessed by host systems via Input/Output (I/O) requests, such as reading and writing, through one or more storage controllers. A user accessing the storage devices through the host system views the multiple storage devices as one or more volumes. Examples of large storage systems include, without limitation, Redundant Array Of Independent Disks (RAID) storage systems that have one or more logical units (LUNs) distributed over a plurality of disks, and spanned volumes (e.g., non-RAID architecture; JBOD, etc.). Examples of the host systems include computing environments, ranging from individual personal computers and workstations to large networked enterprises encompassing numerous types of computing systems. A variety of well-known operating systems may be employed in such computing environments depending upon the needs of particular users and enterprises. Storage devices in such large storage systems may include standard hard disk drives as well as other types of storage devices such as solid-state drives (SSD), optical storage, semiconductor storage (e.g., Random Access Memory disks or RAM disks), tape storage, et cetera.

In many large storage applications, enhanced reliability and data recovery of stored data is of heightened importance. Such reliability and data recovery is often provided through the use of multiple storage elements configured in geometries that permit redundancy of stored data to ensure data integrity in case of various failures. In many such storage systems, recovery from some common failures can be automated within the storage system itself by using data redundancy, error codes, and so-called “hot spares” (extra storage devices which may be activated to replace a failed, previously active storage device). To further improve reliability, it is known in the art to provide redundant storage controllers to reduce the failure rate of the storage system due to, for example, control electronics failures.

In any large storage system, a limiting feature in processing I/O requests is latency in accessing individual storage devices. It will be appreciated that access speeds of many electronic storage components, such as SRAM, DRAM and solid state memory devices, continue to increase, often exponentially. The same has not tended to hold true for mechanical storage components, such as those found in rotating storage devices. For instance, seek latency of a rotating hard drive is limited by actuator arm speed and disk circumference, and throughput of such a rotating hard drive is limited by the rotational speed of the disk. As rotating storage devices continue to be among the most economical storage solution for mass storage systems, the physical limitations of these devices limit the Input/Output Operations Per Second (IOs per Second) for such systems. Such limitations can result in a write cache of a storage controller saturating in I/O intense applications as the write requests cannot be committed to connected storage devices (e.g., rotating storage media) as quickly as they are received.

### SUMMARY

The presented inventions solve the above as well as other problems and advance the state of the useful arts by providing systems, apparatuses and methods (i.e., utilities) for handling I/O write requests from a host system to a storage system. More specifically, the utilities allow for, among other things, the rapid de-allocation (e.g., flushing) of I/O write requests from a controller memory (e.g., primary cache). This is accomplished by utilization of one or more second-level caches that temporarily store I/O write requests and allow for transferring of the I/O write requests to storage devices connected to the storage controllers after the I/O write requests are flushed from the primary cache. To improve utilization of system resources, the second-level cache is formed of solid state drives in a parity RAID configuration.

In one aspect, an I/O write request is received requesting access to physical storage space, such as a block of storage space within a storage volume or logical unit, which is typically formed of a plurality of storage devices. A controller is operatively interconnected to the storage devices. The I/O write request is initially allocated to a primary cache in the controllers. The I/O write request is also transferred to a second-level cache, which is formed of a plurality of SSDs having a parity RAID configuration, which provides redundancy of the write request. Once transferred to the second-level cache, the I/O write request is de-allocated from the memory of the controller. Accordingly, the memory of the controller is available for processing additional I/O requests from host systems. This allows the storage controller to maintain high IOs per second capacity.

In one arrangement, the controller is operative to determine if related data to an I/O write request currently exists in a cache line stored in the second-level cache. Upon determining a related entry exits, the controller is operative to further determine if the new data of the I/O write requests overlaps any existing data within the existing cache line. For example, it may be determined that the new data of the I/O write requests corresponds to a non-valid portion of an existing cache line in the second level cache. In such an arrangement, the new data may be spliced (e.g., written) into the non-valid portion of the existing cache line. The controller is further operative to update the parity of the stripe in the RAID configured second level cache that includes the new data. In the present arrangement, the existing data in the non-valid portion of the cache line has a known value. For instance, the non-valid portion of the cache line may be filled with default values (e.g., ‘1’s or ‘0’s). Accordingly, the updated parity may be calculated without reading the existing data from the non-valid portion of the cache line, saving both a read and XOR operation.

In one arrangement, each cache line stored in the second level cache is stored in an individual segment of a RAID stripe. For example, each cache line may be stored on an individual SSD. In such an arrangement, the block or segment size of the RAID stripe may be substantially equal or equal to the size of the cache line.

In a further arrangement, the utility is operative to fill non-valid portions of a cache line stored to the second level cache with known values. That is, upon writing a cache line to the second level cache, non-valid portions of the cache line may be filled with default values for a storage device. Such default values may include, for example, ‘1’s or ‘0’s. As these values stored in these non-valid portions are known, they need not be re-read when recalculating parity for a stripe in the RAID configured second level cache.

In a yet further arrangement, the controller is operative to identify a plurality of I/O write request for which no existing second-level cache entries exist. In this arrangement, a plurality of I/O write request equaling the number of data segments of the parity RAID second level cache may be identified. For instance, in a RAID 5 (4+1) configured second level cache, four I/O write requests may be identified for storage to four cache lines. The non-valid portion of each of cache line may be filled with default values. At this time, all four cache lines and parity of the cache lines may be striped to the second level cache. That is, a full stripe may be written.

After written to the second-level cache, an I/O write request may be transferred to the storage devices as a background operation. That is, during idle, the controller may buffer the I/O write request and transfer it to the storage devices. At this time, the I/O write request may be flushed from the second-level cache if needed.

In one aspect, the utilities are implemented as methods performed by a storage subsystem. In another aspect, the utilities are implemented as a physical storage subsystem. In a further aspect, the utilities are implemented as instructions stored on a storage medium.

### BRIEF DESCRIPTION OF THE DRAWINGS

FIG. 1 is a block diagram illustrating a network implementing the storage subsystem in accordance with various aspects of the invention.

FIG. 2 is a block diagram illustrating one embodiment of a storage subsystem.

FIG. 3 is a block diagram illustrating an exemplary embodiment of a controller utilized in a storage subsystem.

FIG. 4 is a block diagram illustrating another exemplary embodiment of a storage subsystem.

FIG. 5 is a block diagram illustrating a RAID 5 (4+1) configuration.

FIG. 6 is a block diagram illustrating an embodiment of a storage subsystem utilizing a RAID configured second level cache.

FIGS. 7A, 7B and 7C schematically illustrate a cache line, default filling of the cache line, and splicing of the cache line, respectively.

FIG. 8 is a process flow sheet illustrating an exemplary operation of a storage controller including a parity RAID second level cache.

### DETAILED DESCRIPTION

While the presented inventions are susceptible to various modifications and alternative forms, specific embodiments of the inventions have been shown, by way of example, in the drawings and will herein be described in detail. Those skilled in the art will appreciate that the features described below can be combined in various ways to form multiple variations of the inventions. As a result, the inventions are not limited to the specific examples described below, but only by the claims and their equivalents.

Provided herein is a storage subsystem that utilizes a second-level cache to improve Input/Output operations. In one arrangement, the storage subsystem is operative to rapidly flush I/O write requests from a main memory (e.g., DRAM) or primary cache (e.g., first level cache) after transferring the I/O write requests to a second-level cache. When processing capacity is available, the I/O write requests are subsequently transferred from the second-level cache to one or more storage devices.

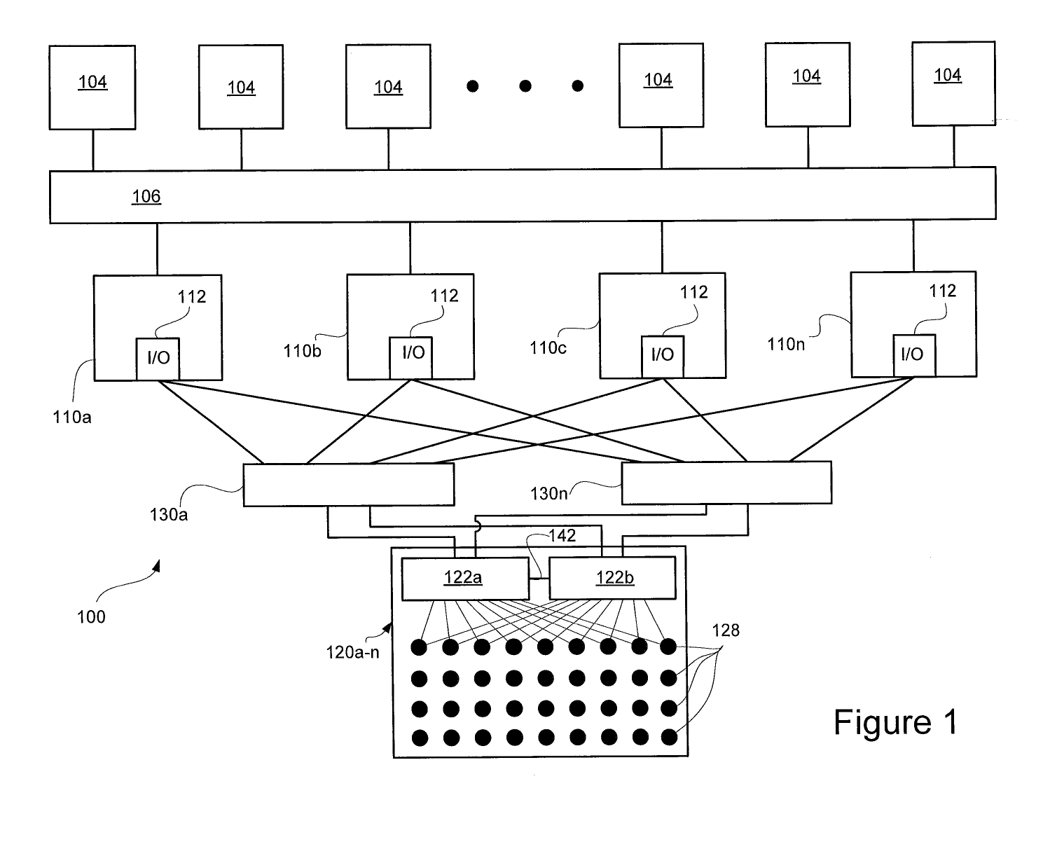

With reference now to the figures and in particular with reference to FIG. 1, an exemplary embodiment of a storage subsystem 120, in accordance with aspects of the presented inventions, is provided. As shown, a computing network 100 includes multiple servers/host systems 110a-n connected to multiple storage subsystems 120a-n (only one shown for clarity) via multiple switches 130a-n (hereafter 110, 120 and 130, respectively, unless specifically identified), where the switches collectively define a switching fabric. The host systems 110 are typically interconnected to a plurality of computing devices 104 via a high speed network 106. Such high speed networks may include, for example, the interne, a local area network (LAN), a wide area network (WAN), or any other suitable network communications channel. These devices can be any of a variety of computing devices including, for example, laptops, desktops, workstations, handheld/wireless computing devices, or other computing devices. Data migration between the storage subsystems 120 and the computing devices 104 is managed by the host systems 110. Details of the connections between the computing devices 104 and host systems 120 are known to those skilled in the art.

The storage subsystems 120 are configured for handling I/O requests from the host systems 110, which communicate with the computing devices 104. The host systems 110 may be communicatively connected to the storage subsystems 120 for processing I/O requests through a variety of connections. Examples of such connections include Fibre Channel (FC), Small Computer System Interface (SCSI), Internet SCSI (ISCSI), Ethernet, Infiniband, SCSI over Infiniband, piping, and/or various physical connections. A variety of well-known operating systems may be employed in such computing environments depending upon the needs of particular users and enterprises.

I/O modules 112 process I/O requests from the host systems 110 in order to access physical storage space within the storage subsystems 120. The I/O modules 112 have host connect interfaces for receiving I/O requests from the host systems and transferring data between the host systems 110 and the storage subsystems 120. The I/O modules 112 can connect to the host systems through a variety of means. Each I/O module is communicatively connected to the switching fabric through multiple communications switches, such as Application Specific Integrated Circuits (ASIC), configured to route data from a host system 110, through the switching fabric, and on to storage elements or devices of a storage subsystem according to a specific address. Those skilled in the art are familiar with communications switches and will readily recognize the design of such switches (e.g., custom ASICs) for purposes of transferring messages through such a switched fabric or other communication medium.

In the present embodiment, the I/O requests are transferred from the I/O modules 112 to storage devices of the storage subsystems 120 through the switches 130 of the switching fabric. Each of the storage subsystems 120 typically includes a plurality of individual storage devices 128, such as rotating media/disks and/or other types of storage devices (e.g., solid state drives, optical storage, tape storage, semiconductor storage) that may be arranged into one or more logical units (LUNs) and controlled by a controller and more typically at least a pair of redundant controllers 122a, 122b. The storage devices and storage controllers can be configured to employ any of a number of storage management schemes, such as that of a RAID storage management system (e.g., Raid 0, 3, 4, 5, 6 etc.). In such an arrangement, the storage controllers may include RAID storage controllers for processing the requests of host systems 110 through I/O modules 112 and communication switches 130. However, the presented embodiments are not limited to only RAID configurations.

In the illustrated embodiment, the storage devices 128 can appear as a single virtual storage system to the host systems. In operation, the I/O requests includes a Command Data Block (CDB) that contains information (e.g., Logical Unit Identifier (LUN) and offset or Logical Block Address (LBA)) regarding the location of data in terms of the virtual storage system. This information is translated into a new I/O request relating to the physical location in the appropriate storage subsystem. Thus, mapping tables may be implemented for translating virtual storage locations of the virtual storage system into physical storage locations of the storage subsystems (i.e., storage locations of the individual storage devices). Data may then be written or retrieved from the storage devices by the controllers of the appropriate storage subsystem.

In the present embodiment, each of the controllers 122a, 122b is operatively connectable with each of the individual storage devices 128 to affect such read/write requests (all connections are not shown for purposes of clarity). The illustrated embodiment also utilizes redundant connections between each host system 110, switch 130, and storage subsystem 120. For example, a first host system 120a is interconnected to two fabric switches 130a, 130b, which are, in turn, each connected to each controller 122a, 122b of a storage subsystem 120a. In this regard, dual path architecture is utilized to provide redundant paths between the host system 110a and the storage subsystem 120a. One of the features of such architecture is capability of failover; meaning that in case one path fails or a fabric switch 130a fails, data can be sent via the second fabric switch 130b. The number of host systems 110, storage subsystems 120, fabric switches 130 and I/O modules 112 forming the network 100 is not intended to be limited to the number of host systems 110, storage subsystems 120, fabric switches 130, and/or I/O modules 112 in the present embodiment.

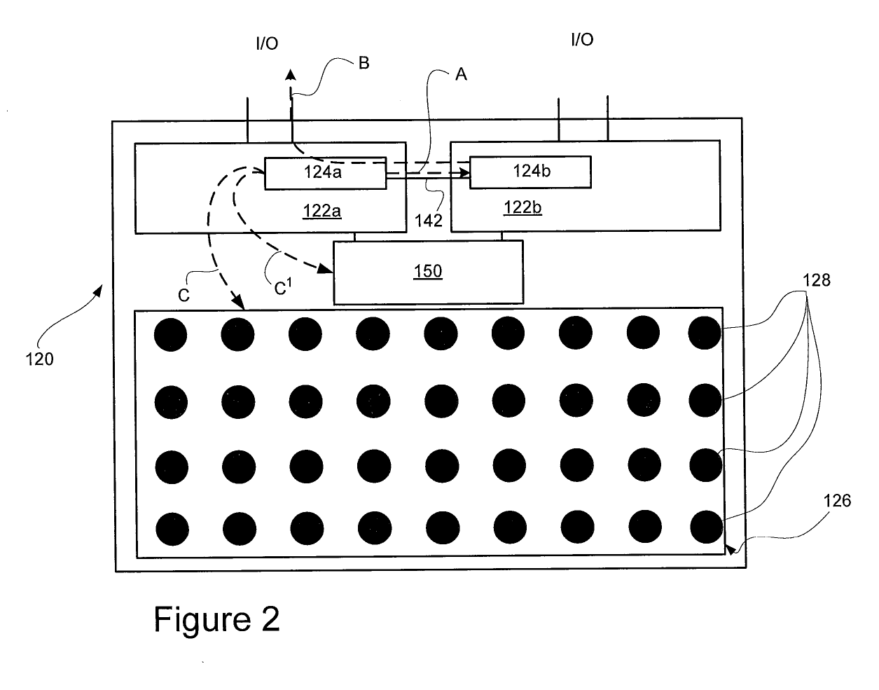

Like the use of redundant connections, the use of the redundant storage controllers 122a, 122b in each of the storage subsystems 120 can reduce the failure rate of the storage subsystem due to control electronics failures. In this arrangement, the redundant pair of controllers 122a, 122b control the same storage devices 128 (e.g., array of storage devices 126). See FIG. 2. A memory 124a, 124b is operatively connected with each of the controllers 122a, 122b and the redundant controllers communicate with one another to ensure that the memories 124a, 124b are synchronized. In this regard, I/O requests are mirrored in the memory of each controller. That is, if a first controller 122a receives an I/O request, this I/O request is stored in allocated memory blocks (e.g., primary cache) in the memory 124a of the first controller and mirrored (e.g., copied) to allocated memory blocks in the memory 124b of the second controller, for example, via an Inter-Controller Channel 142 (ICL) physically interconnecting the controllers 122a, 122b. This is illustrated by dashed arrow ‘A’ in FIG. 2. In such an arrangement, if the first controller experiences a failure, the second controller may continue processing the I/O request while the first controller is repaired or replaced. Though illustrated to show the first controller 122a handling the I/O request, it will be appreciated that the second controller 122b likewise handles I/O requests (e.g., simultaneously with the first controller 122a). That is, each controller 122a, 122b is typically assigned and handles I/O requests for a portion of the storage devices 128, which may be configured into various logical units (LUNs). More specifically, each controller typically handles the I/O requests for its assigned LUNs. Accordingly, all discussion herein to handling of I/O requests by the first controller 122a is likewise applicable to handling of I/O requests by the second controller 122b.

The storage subsystem 120 may also incorporate a second-level cache 150 (e.g., read cache) for storing frequently accessed data from the storage devices 128 and/or for storing recently written I/O write requests, such that this information is available from the second-level cache for future read requests. The second-level cache 150 may be a flash memory device that may be pre-loaded (e.g., pre-warmed) with frequently accessed data from the storage devices 128. When the second-level cache 150 fills, it may be flushed utilizing least recently used (LRU) or similar staleness algorithms as known to those skilled in the art. Though shown as a single device, it will be appreciated that the second-level cache may incorporate multiple individual devices (e.g., SSDs) and these individual devices may be allocated between the controllers.

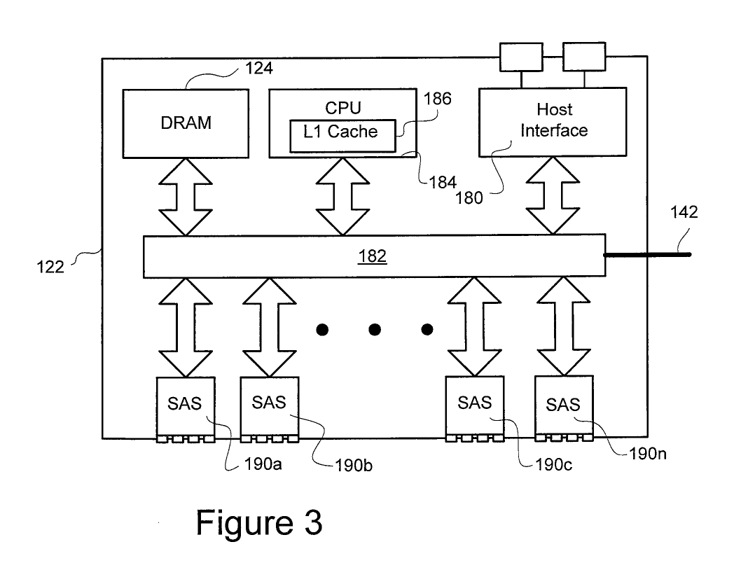

FIG. 3 illustrates an exemplary embodiment of one of the controllers 122a, 122b, hereafter referred to as “controller” 122. It will be appreciated that architecture of the other controller can be identical. In the one embodiment, the controller is primarily formed of embedded firmware. However, it will be appreciated that other embodiments may comprise software and/or hardware implementations. As shown, the controller 122 includes a multi-ported host interface 180 or front-end interface that is capable of communicating with a host system, such as the host system 110 of FIG. 1, through a variety of means, including, without limitation, FC, SCSI, SCSI ISCSI, SAS, PCIe, Ethernet, Infiniband, SCSI over Infiniband, piping, and/or various physical connections. The host interface 180 may comprise one or more individual circuits or chips (e.g., ASICs). In any arrangement, the host interface 180 receives an I/O request from the host system to access a block of storage space within a storage device. The host interface 180 transfers that I/O request to the memory 124 of the controller 122 via a bus 182. In one embodiment, such transfer may comprise a Direct Memory Access (DMA) transfer such that the I/O request is stored to allocated memory blocks within the primary cache 186 or the memory 124 (DRAM) independent of operation of the processor 184 of the controller 122. The I/O request is likewise provided to the ICL 142 such that it may be copied in allocated memory blocks in the primary cache of the memory of the other controller.

Once the I/O request is stored in memory 124 (e.g., SRAM or DRAM), the processor 184 accesses the I/O request, in the case of read request, and determines if the requested data exists within the primary cache or second-level cache (see for example FIG. 2). If so, the data is retrieved from the appropriate cache and output to the requesting host system via the host interface 180. If not, the processor 184 accesses the storage devices through the back end interface, which, in the present embodiment, is a plurality of Serial Attached SCSI (SAS) chips 190a-n. However, it will be appreciated that other back-end protocols/architectures such as, without limitation, SATA, SCSI, Ethernet, PCIe, and FC may be utilized in the back-end interface. When the I/O request is a write request, the write data is output to the storage devices and/or a second-level cache via the back-end interface, typically through a DMA request. The ports of the SAS chips 190a-n are interconnected to one or more arrays 126 of storage devices 128 via SAS connectors (not shown). Each array may include appropriate I/O modules (e.g., SAS expanders, etc) as known to those skilled in the art. Additionally, one or more solid state drive (SSD) second-level caches may be connected to ports of the SAS chips 190a-n.

A limiting feature in processing I/O requests by the controllers 122 is the latency in accessing the storage devices 128. This can be more apparent when the I/O request includes multiple write requests that require data to be stored to relatively slow (e.g., in comparison with the controller memory) rotating media. To improve performance of the storage subsystem, a write-back cache may be utilized by the storage controllers. In this arrangement, when one storage controller (e.g., controller 122a) receives a request to write data to the storage devices 128, this data is stored in a write cache (e.g., primary cache or DRAM) of that controller 122a and mirrored in the write cache of the second controller 122b, as illustrated by dashed arrow A. At this time, a command-complete signal can be returned to the requesting host indicating that the write operation is complete, as illustrated by dashed arrow B. Some embodiments send this command complete signal before the data is actually written to the storage devices 128, as a back-up copy exists in the memory 124b of the second controller 122b.

In the absence of a failure of the receiving controller 122a, the receiving controller 122a writes the data to the storage devices 128, as illustrated by dashed arrow C. Once written to the storage devices 128, a write complete signal is generated and the memory blocks of the two controllers 122a, and 122b may be de-allocated, freeing these memory blocks for storage of subsequent I/O requests. If the receiving controller 122a were to fail prior completing the write request, the second controller 122b would complete the write. As illustrated in FIG. 2, in addition to writing the data to the storage devices, the data may be mirrored (e.g., simultaneously) to the second-level cache 150, as illustrated by dashed arrow C¹.

Notwithstanding the use of write-back caching of I/O requests, in I/O intensive applications (e.g., small-block write applications), the storage controller memory 124 often receives I/O write requests faster than the requests can be processed. In such instances, the primary cache of the controller can become overwhelmed while waiting on the relatively slow flush to the storage devices 128. That is, pending I/O requests (i.e., the I/O stack) may fill the primary write cache. Performance of the storage subsystem 120 slows after the primary write cache fills. That is, new write requests from the I/O modules 112 are delayed until blocks in the controller memories 124a, 124b are de-allocated and available to store new I/O requests.

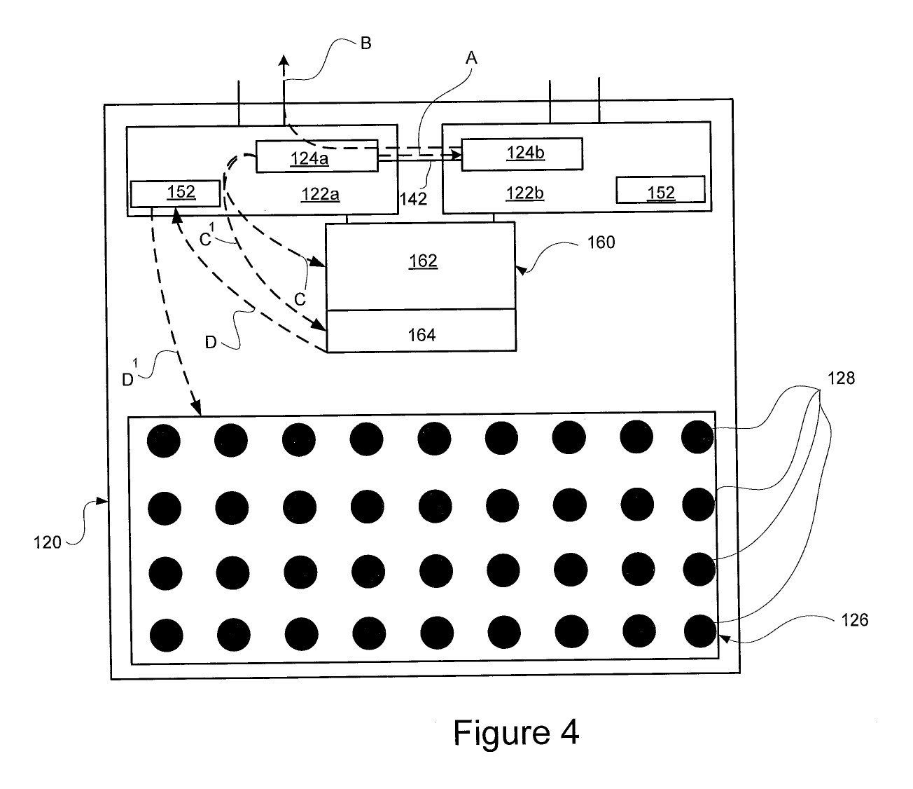

FIG. 4 illustrates the storage subsystem 120 utilizing redundant controllers 122a, 122b and further incorporating a solid-state drive (SSD) 160 that operates as a second level cache to receive read and write operations originating from the controllers. As above, when one storage controller (e.g., controller 122a) receives a request to write data to the storage devices 128, this data is stored in a write cache of that controller 122a and mirrored in the write cache of the second controller 122b (illustrated by dashed arrow A) and a command complete signal is returned to the requesting host indicating that the write operation is complete (illustrated by dashed arrow B). However, in this embodiment, the receiving controller 122a schedules the write operation to the SSD 160 as illustrated by dashed arrow C. Once the data is mirrored (e.g., copied) to the SSD 160, a write-complete signal is generated and the memory blocks of the primary write caches of the two controllers 122a, 122b are de-allocated, thus freeing these memory blocks for the storage of subsequent I/O requests. The data in the solid-state drive 160 may then be transferred to the storage devices 128, which may be completed as a background operation from the view of the controllers 122a, 122b. In this regard, one of the controllers 122a, 122b (i.e., typically the controller that received the I/O write request) may be utilized to buffer the data and transfer the data to the storage devices 128, as illustrated by dashed arrows D and D¹. This data may be buffered in allocated memory (e.g., DRAM) of the controller or may be buffered in a separate buffer 152. In either embodiment, transfer of the data may occur during processor idle to preserve the IOs per second of the controller.

If the write request data were written to a single SSD 160 in a single location, no redundancy would exist for the I/O write request data. In this regard, failure of the solid-state drive 160 would result in loss of the I/O write request data. In order to provide a redundancy for the I/O write request data, separate SSDs may be utilized for the second level cache, a read cache 162 and a mirror cache 164. In this embodiment, the receiving controller 122a simultaneously schedules the write operation to both the read cache 162 and the mirror cache 164, as illustrated by dashed arrows C and C¹. The mirror cache 164 acts as a mirror for the unexecuted I/O write request data within the read cache 162 thereby providing a redundant copy of the I/O write request data. Once the I/O write request data is written to the read cache 162 and the mirror cache 164, a command-complete signal is generated and the memory blocks of the two controller primary caches may be de-allocated, quickly freeing these memories for additional write operations. After stored to the mirror cache 164, one of the controllers may buffer the data of the I/O write request from the read cache 162 or mirror cache 164 and transfer that data to the storage devices 128 when processing capability is available. In one embodiment, a serial buffer 152 is utilized to prevent over-allocation of controller memory resources for handling the transfer of data between the read cache 162 or mirror cache 164 and the storage devices 128. As soon as those write requests are transferred to the storage devices 128, as illustrated by dashed arrows D and D¹, the I/O write request may be removed from the mirror cache 164 as the data is now stored to the storage devices 128, which may provide redundant copies thereof. That is, the I/O write request may be flushed or marked as de-allocated and invalid so the location within the mirror cache 164 can be reused.

While utilization of a second-level cache having two SSD's (i.e., read cache 162 and mirror cache 164) that store a read copy and a mirror copy of the data provides desired redundancy, such an arrangement does not make the best use of system resources. That is, while data written identically to two drives produces a “mirrored set”, the in-use capacity of the SSDs is only 50%. Accordingly, the inventors have recognized that other configurations of a second-level cache could provide redundancy while increasing the in-use capacity of the SSDs that form the second-level cache. Specifically, the inventors have recognized that a RAID (redundant array of independent disks) configuration or level having parity (i.e., parity RAID) could be implemented for the second-level cache to provide redundancy while increasing in-use capacity.

RAID configurations allow segmenting logically sequential data, such as a file, so that consecutive segments are stored on different physical storage devices. This is typically done by interleaving sequential segments of the data on separate storage devices in a round-robin fashion on multiple drives from the beginning of the data. That is, RAID levels that use striping split up files or data sets into small pieces and distributing them to multiple drives. Most striping implementations allow a user to control over two parameters that define the way that the data is broken into chunks and sent to the various drives. The first parameter is the stripe width of the array. Stripe width refers to the number of parallel stripes that can be written to or read from simultaneously. This is equal to the number of drives in the array. So a five-disk striped array has a stripe width of five. Read and write performance of a striped array increases as stripe width increases. That is, adding more drives to the array increases the parallelism of the array, allowing access to more drives simultaneously. The second parameter is the stripe size of the array, sometimes also referred to by terms such as block size, chunk size, stripe length or granularity. This term refers to the size of the stripes written to each disk. RAID arrays that stripe in blocks typically allow the selection of block sizes in kB ranging from 2 kB to 512 kB (or even higher) in powers of two (e.g., 2 kB, 4 kB, 8 kB, 16 kB etc.). As stripe size is decreased, files are broken into smaller and smaller pieces. This increases the number of drives that a file or data set will use to hold all the blocks containing the data of that file/data set. Increasing the stripe size does the opposite of decreasing it. Fewer drives are required to store files/data sets of a given size. As will be appreciated, stripe width and stripe size may be varied as utilized with the second-level cache.

Many RAID levels employ an error protection scheme called “parity”, a commonly used method in information technology to provide fault tolerance in a given set of data. That is, parity data is used by some RAID configurations or levels to achieve redundancy. While writing data to a stripe, a file or data set is broken into chunks and written in separate segments on different drives. One segment of each stripe is reserved for parity data which is calculated from the data in on the other drives of the stripe. If a drive in the array fails, remaining data on the other drives can be combined with the parity data, which is commonly calculated using an XOR function, to reconstruct the missing data. That is, the XOR function generates a checksum value that is based on the values of the other data blocks in a given stripe. Stated otherwise, if the data in one of the segments of a stripe becomes corrupted, or, if the drive associated with that segments fails, the remaining data in the other segments/drives and the parity data can be used to reconstruct the lost data. Those skilled in the art are familiar with parity calculations.

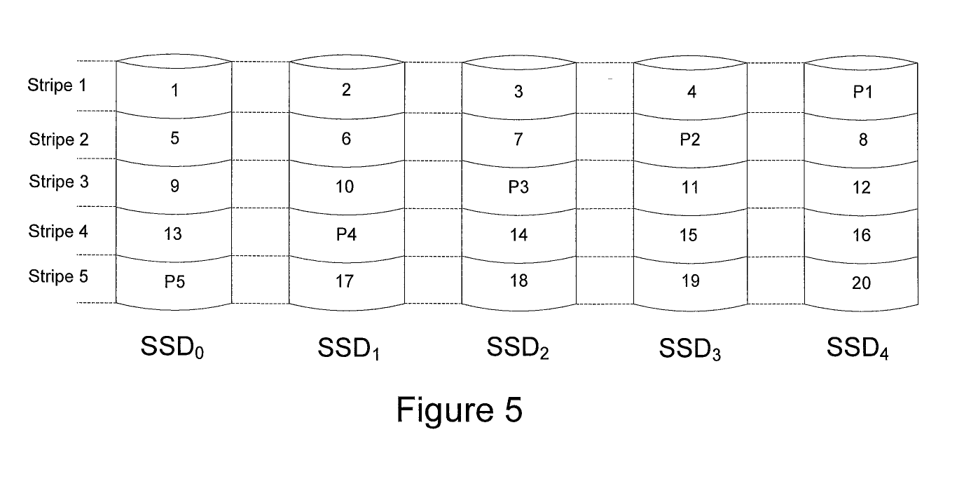

FIG. 5 illustrates five SSDs configured in a Raid 5 (4+1) configuration that may be utilized as the second-level cache. However, it will be appreciated that other RAID configurations that provide redundancy such as parity may be utilized and that the embodiment of FIG. 5 is by way of example and not limitation. As illustrated, there are five SSDs (i.e., SSD₀-SSD₄) across which data is striped. The numbered segments (e.g., 1-4 in Stripe 1) represent data segments or blocks on the RAID 5 set or volume, while the P segment contains parity data of each stripe. Of note, in a RAID 5 configuration, the parity segment P is shifted between stripes. RAID 4 is similar, except in RAID 4 one dedicated drive is used for parity.

As illustrated in the RAID 5 (4+1) configuration of FIG. 5, there are 4 segments carrying data plus one parity segment per stripe. Though five stripes are illustrated, it will be appreciated that numerous additional stripes may be present. This arrangement provides improved in-use performance of system resources. That is, for a second-level cache utilizing the illustrated RAID 5 (4+1) configuration, the in-use capacity of the SSDs forming the second level cache is 80%. Other RAID configurations may provide different in-use capacities (e.g., RAID 5 (8+1)), however, such configurations will typically have in-use capacities in excess of that of simple mirroring. In the case of RAID 5 (4+1), four segments of each stripe store data and the fifth stores parity data. Accordingly, fewer SSDs are required to provide a second-level cache of a desired size (i.e., in comparison with a mirrored set of drives) while still providing redundancy for the second-level cache.

One previous drawback of utilizing a parity RAID configuration is the write cost or penalty associated with writing less than an entire RAID stripe. That is, when writing data to less than an entire stripe, it is necessary to access a number of drives of the stripe to effect writing of the data and recalculation of parity data for the stripe. That is, after a stripe is written and an initial parity is calculated for the stripe, later modification of one of the segments of the stripe requires recalculating the parity in addition to writing the new data. Upon receiving a request to modify a segment of an existing stripe, the controller must recalculate the parity by subtracting the data of the old segment and adding in the new version of the segment. In two separate operations, the controller writes the new data segment followed by the new parity segment. To do this, the controller must first read the parity segment from whichever drive contains the parity for the stripe and reread the unmodified data for the updated segment from the drive containing this segment. This read-read-write-write is known as the RAID5 write penalty. Since these two reads and two writes are sequential and synchronous a command-complete signal cannot return until both reads and both writes complete to ensure no data is lost. Therefore, writing to RAID 5 is up to 50% slower than RAID 0 for an array of the same capacity.

The write penalty is further discussed in relation to FIG. 5. Assuming that stripe 1 has previously been written and that P1 has previously been calculated, modification of segment 1 would require the following:

Read segment 1 from SSD0;

Read the parity segment P1 from SSD4;

Recalculate the parity using the “old data” of segment 1 and “new data” of segment 1 and the “old parity” of P1;

Write the new data to segment 1 of SSD0;

Write the new parity to P1 of SSD4.

Where one read request or one write request=1 IO operation performed by the controller, a total of four IO's are required to complete modifying a single segment of stripe 1 of the RAID 5 volume. This is called a “write penalty of four”, because four IO's for every single segment write. Modification of additional stripe segments results in differing write penalties. Generally, such a process where the controller reads data, modifies one or more segments and writes one or more segments is referred to as a Read Modify Write (RMW) process.

In contrast, significant efficiencies are achieved when writing a full stripe. In such a situation, all segments are replaced and new parity can be calculated without reading the old parity:

Calculate the parity using new data segments 1-4;

Write the new data to segments 1-4 of SSD0-SSD4;

Write the new parity to P1 of SSD4

This operation requires five IO's for modifying four segments resulting in a 1.25 write penalty. In summary, RAID 5 has high performance when writing a full stripe by suffers from read-modify-write (RMW) performance when writing a fraction of a stripe.

In view of the above-noted examples, the inventors have recognized that it would be beneficial to preferentially utilize a full stripe write, when possible, and, when not possible, to reduce the number of reads operations required to modify a stripe segment. In the latter regard, it will be appreciated that an enterprise level storage controller may receive and execute millions of write requests per day and that saving a read IO in at least a portion of those requests will result in significant computational savings for the controller.

Aspects of the invention are based on the recognitions that the default values of bits in a storage device (e.g., SSD) are either ‘0’ or ‘1’, depending on the manufacturer of the storage device and that, in many instances, a cache write request involves the modification of an existing cache line. Further, such a modification sometimes involves writing data to a portion of an existing cache line where no previous data exists. That is, in some instances, data may be written (e.g., spliced) into a previously non-valid portion of a cache line. In instances where an existing cache line is stored in a RAID stripe, the non-valid portion of the cache line may be filled with default values of the storage device (e.g., SSD). Accordingly, these default values are known and, upon writing ‘new data’ to an non-valid portion of the existing cache line, the ‘old data’ need not be reread for parity calculations. That is, when new data is written to a location of a RAID stripe that includes default values, there is no need to read the old data as this data is known (i.e., ‘0’ or ‘1’). Accordingly, in a RMW situation where an non-valid portion an existing cache line is modified in a RAID 5 stripe, rather than performing two reads and two writes to update the data, the RMW requires only a single read (e.g., old parity), calculation of the new parity based on the new data and the known old data (i.e., ‘0’ or ‘1’), and two writes to write the new data and the new parity. In this regard, a savings of 25% of the IOs required for the RMW may be achieved. Likewise, a 25% increase in bandwidth may be recognized. Further an XOR operation is saved.

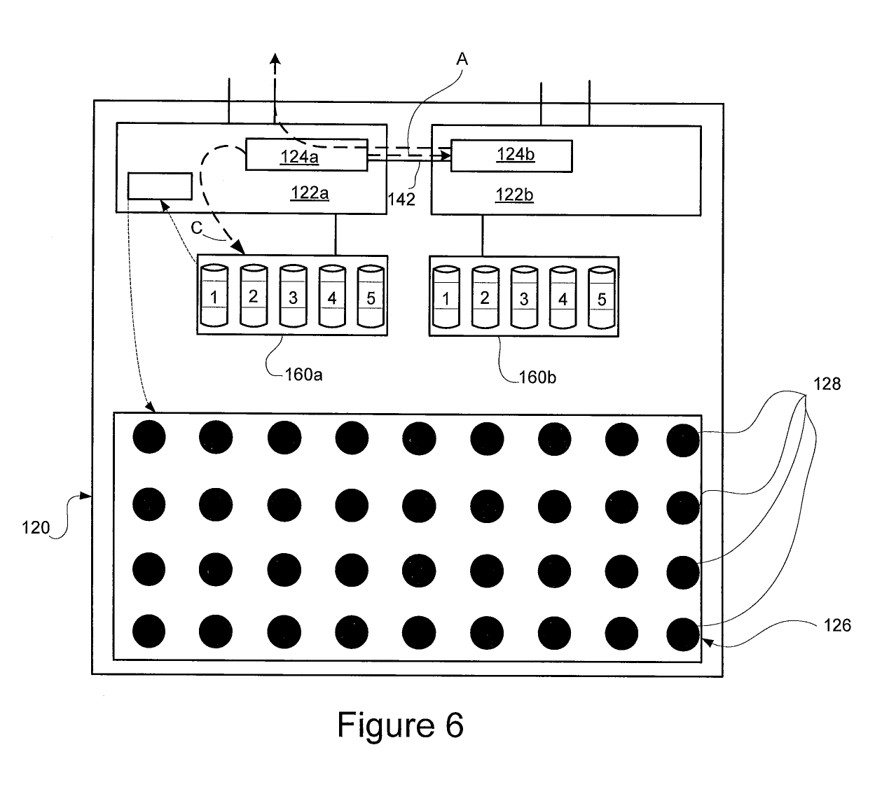

FIG. 6 illustrates a system that utilizes multiple SSDs in a RAID 5 (4+1) configuration as second level caches 160a, 160b. In this arrangement, the controllers further operate as RAID controllers operative to stripe data across the SSDs of the second level caches. In one embodiment, the RAID 5 configuration utilizes a small chunk/stripe size that approximate the size of the second level cache line. By matching the stripe size of the RAID stripe segments to the cache line size, the likelihood of obtaining a full stripe of valid data is increased. However, this is not a requirement. In one specific embodiment, the RAID 5 configuration has a stripe size of 128 Kb with a segment size of 32 Kb and the second level cache has a cache line size of 32 Kb.

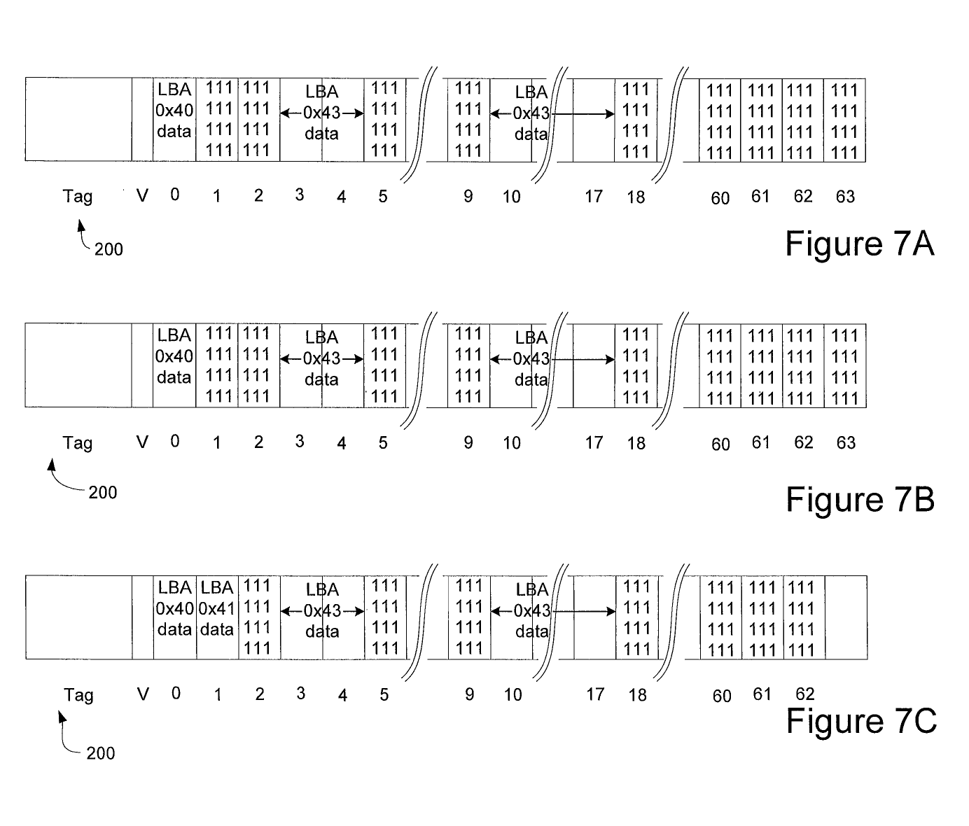

FIG. 7A illustrates an exemplary cache line for the second-level cache. As shown, the cache line 200 is a fully associative cache where the cache line is in a single row including multiple cache line blocks 0-63. In the present embodiment, the cache line has a size of 32 Kb and includes a tag 202, a validity flag V and 64 cache line blocks (0-63) each having a size of 512 bytes (not to scale). Though illustrated as a full associative cache, it will be appreciated that other cache mapping schemes may be utilized and that the illustrated embodiment is presented by way of example and not by way of limitation.

When one or more I/O write requests are received by the controller and transferred to the second-level cache, a cache entry or cache line is created. As will be appreciated, data is transferred between the caches in cache lines having a fixed size, in this case 32 Kb. The cache line will include the data of the write request as well as the requested memory location (i.e., tag). The cache line 200 will include the data of the write request stored in one or more of the cache line blocks 0-63 as well as the requested memory location. For instance, in a situation where a host writes a block to LBA 0x40, a 4K block to LBA 0x50 and a 2 block write to 0x43 of the storage subsystem 120 (See, e.g., FIG. 6), the controller may generate write (e.g., second-level cache line), which will be a 32K write with data at cache line offset 0x0 (1 cache line block), cache line offset 0x3 (2 cache line blocks) and cache line offset 0x10 (8 cache line blocks). This is illustrates in FIG. 7B. In addition, the unused cache line blocks 1-2, 7-15 and 11-63 of the cache line are filled with the default values (e.g., ‘1’ or ‘0’), which are illustrated in FIG. 7B as being filled with 1's. That is, the unused or non-valid portions of the cache line 200 are filled with default values of the storage device to which the cache line will be stored (e.g., SSD). The location of the non-valid data in the cache line is recorded in metadata maintained by the controller. Once the cache line is generated, the cache line is written to a segment of a stripe of the RAID 5 second level cache. In operation, it is preferable that four such cache lines are generated and stored to each data segment a single stripe in the RAID 5 second level cache such that a full stripe write may be performed to achieve the above-noted benefits.

After the cache line is striped to the second level-cache, subsequent write request may be received that correspond to one or more write requests in a stored cache line. In this regard, when a host writes a block to a location in memory, the controller first checks for an associated entry in the second level cache. That is, the second level cache is searched for contents of the requested memory location in any cache lines that contain an associated address. If the controller finds that an associated memory location is in the second level cache, a cache hit has occurred. If a cache hit occurs, one of two processes may occur, the cache line may be replaced with the new cache line or the cache line may be modified to include new data of the new write request. Such modification requires the addition of valid bits within previously non-valid blocks of a cache line (i.e., splicing). In such an arrangement, valid bits are usually added to a previously non-valid blocks of the cache line. That is, data can be spliced into one or more non-valid block of the cache line and the remainder of the cache line blocks may again be marked non-valid.

The splicing of new data for an address existing in a previously stored cache line is illustrated in FIG. 7C. For example, upon receiving an additional host write for another block in LBA 0x41, the previously stored cache line may be identified as having an associated address. If the new write data does not overlap the previous data (e.g., old data) for the LBA address, the new data may be spliced into the existing cache line. This is illustrated in FIG. 7C where the new LBA 0x41 data is inserted into cache line offset 0x1 (1 cache line block).

In the present embodiment where the cache line is modified in a parity RAID configured second level cache, the modification of the cache line requires the updating of the parity information for the stripe of the second level cache that includes the cache line. However, as previously outlined, as the new data overwrites existing data having a known value (e.g., 1's in offset 0x11), the old data in this offset does not have to be read to calculate the new parity. Accordingly, the new parity may be calculated and stored to the SSD containing the parity information for the stripe including the cache line.

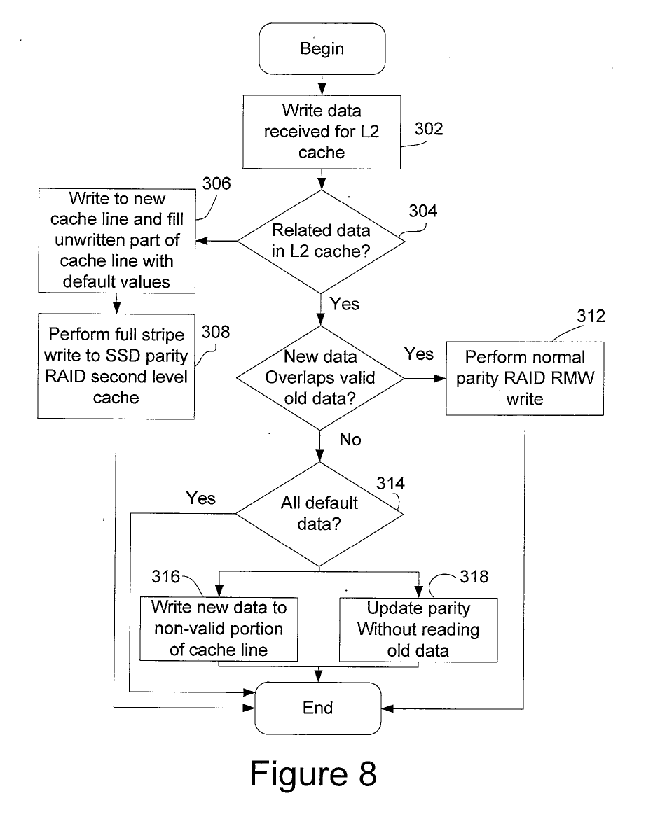

FIG. 8 illustrates a process 300 that may be utilized in conjunction with a parity RAID second level cache. Initially, write data (i.e., a host write request) may be received 302 (e.g., by storage controller). The storage controller is operative to determine 304 if data related to the write data currently exists in the second level cache. In the situation where no related data exists in the second level cache, the write data is written 306 to a new cache line and non-valid parts of the cache line are written to a default value (e.g., ‘1’ or ‘0’). This cache line, once filled with default values, preferably has a size equal to the segment size of the parity RAID second level cache. Accordingly, in the situation where a RAID 5 (4+1) configuration is utilized for the second level cache, it is desirable to collect a total of four cache lines, each having the size of an individual segment of the RAID stripe, such that a full stripe write may be written 308 to the parity RAID second level cache.

In contrast, when there is related data in the second level cache, a determination 310 is made as to whether the new write data overlaps any valid old data within the second level cache. If the new data overlaps the old data, the new data cannot be spliced into an existing cache line without performing a normal RMW process. Accordingly, a normal RMW process is performed 312. If the new data does not overlap the old data, a determination 314 is made as to whether the new data has all default values (e.g., ‘1’ or ‘0’). If so, the new data is discarded as the existing data in the cache line is already set to the default value. If the new data is not all default values, the new data is written 316 to a non-valid portion of the related cache line and the parity of the stripe containing the cache line is updated 318 without reading the old data. The order of these operations 316, 318 are independent.

Though illustrated in FIG. 6 as having a single RAID 5 (4+1) second level cache for each controller, it will be appreciated that each controller may include multiple sets of RAID second level caches. That is, the number second level caches (e.g., each comprising a five SSDs in a RAID 5 (4+1) or other configuration) connected to each controller may be tailored to that controller. For instance, the set of RAID second level caches may be selected to match a data transfer rate of the controller and/or to match the cache size to a working set size. In a situation where the controller has a peak data rate of 20 gigabytes/second and each SSD in the RAID set has a peak data rate of 500 Mb/sec, forty SSDs may be utilized to form the second level cache. That is, five sets of RAID 5 (4+1) SSDs may be utilized as the second level cache. In such an arrangement, the controller may be operable to utilize all five sets the SSDs for handling I/O write requests.

Further, the storage subsystem can be implemented in a number of configurations. For example, in one embodiment, the storage subsystem 120 can be implemented in a 4 U form factor chassis for an enterprise version. In one arrangement, the first and second controllers are implemented in separate 3 U units that are co-located with a 1 U uninterruptable power supply (UPS), which provide emergency power to their respective controller unit in the event that a main input power source is interrupted. The remainder of the chassis may house 4 U arrays of storage devices, which in one embodiment, each comprise 60 or 84 storage devices. The SSDs of the second level cache may be housed within one of the units. In any arrangement, necessary cabling (e.g., SAS connectors) extends between the controllers, SSDs, and storage devices.

Instructions that perform the operations above can be stored on storage media. The instructions can be retrieved and executed by a microprocessor. Some examples of instructions are software, program code, and firmware. Some examples of storage media are memory devices, tapes, disks, integrated circuits, and servers. The instructions are operational when executed by the microprocessor to direct the microprocessor to operate in accord with the invention. Those skilled in the art are familiar with instructions and storage media.

While the preceding examples illustrate processing I/O requests from a host system, the examples are not intended to be limiting. Those skilled in the art understand that other combinations of processing I/O requests at a storage controller or pair of redundant storage controllers will fall within the scope of the invention. Those skilled in the art will also understand that other methods can be used to process requests that fall within the scope of the invention.

Features of the inventions include increasing the IOs per Second of a storage controller through the intermediate storage of I/O write requests to one or more parity RAID SSDs, which allows for earlier de-allocation (e.g., flushing) of the controller memory. Other features include improved write request management of numerous small block write requests (e.g., 512-16 k bytes) though the storage subsystem of the presented invention is likewise beneficial for large block write requests.

While the inventions have been illustrated and described in the drawings and foregoing description, such illustration and description is to be considered as exemplary and not restrictive in character. Protection is desired for all changes and modifications that come within the spirit of the inventions. Those skilled in the art will appreciate variations of the above-described embodiments that fall within the scope of the inventions. As a result, the inventions are not limited to the specific examples and illustrations discussed above, but only by the following claims and their equivalents.

What is claimed:

1. A method of managing write requests of host systems in a storage subsystem having a plurality of storage devices configured as one or more logical units providing data storage, the storage subsystem further comprising a plurality of Solid State Drives (SSDs) forming a second level cache in a parity RAID configuration, the method comprising:
receiving an I/O write request at a storage controller, the I/O write request addressing a storage location for new data within the storage devices of the storage subsystem;
identifying a related address in a cache line of said second level cache, wherein said cache line is stored in a RAID stripe of said second level cache;
identifying a cache storage location in said cache line for said I/O write request as non-valid, wherein said non-valid portion of said cache line is filled with known default values,
calculating an updated parity for said RAID stripe of said second level cache including said cache line based on said new data and said known default values, wherein said updated parity is calculated free of reading said non-valid portion of said cache line;
writing said new data to said non-valid portion of said cache line in said RAID stripe of said second level cache and writing said updated parity to said RAID stripe.

2. The method of claim 1, wherein said cache line is stored within a single data segment of said RAID stripe on one of said plurality of SSDs.

3. The method of claim 2, wherein a size of said cache line and a size of said single data segment are substantially equal.

4. The method of claim 1, further comprising:
maintaining data related to valid and invalid portions of said cache line.

5. The method of claim 4, further comprising changing an identification of said non-valid portion of said cache line to valid after writing said new data to said non-valid portion of said cache line.

6. The method of claim 1, further comprising:
upon initially writing said cache line to said RAID stripe, filling non-valid portions of said cache line with said default values.

7. The method of claim 6, further comprising:
storing plurality of cache lines to a matching plurality of data segments of said RAID stripe, wherein non-valid portions of each cache line are filled with default values and said initially writing comprises performing a full stripe write.

8. The method of claim 1, wherein calculating said updated parity free of reading said non-valid portion of said cache line comprises calculating said updated parity free of performing a read of one of said SSDs containing said cache line.

9. The method of claim 1, wherein said updated parity is written independent of writing said new data.

10. The method of claim 1, subsequent writing said new data to said non-valid portion of said cache line in said RAID stripe of said second level cache, de-allocating allocated storage blocks in a primary cache of said controller.

11. The method of claim 10, wherein the new data of the I/O write request is transferred during idle of the controller from the second level cache to the storage devices.

13. A storage system, including:
a plurality of storage devices configurable as one of more logical units for providing data storage;
a controller having a front-end interface for receiving I/O requests from host systems, a back-end interface interconnected to the plurality of storage devices for selectively transferring the I/O requests to the storage devices;
a primary cache for storing I/O requests to allocated memory blocks
a plurality of solid state drives (SSDs) in a parity RAID configuration operatively interconnected said controller, wherein said plurality of SSDs define a second level cache and said controller is operative to stripe data across said SSDs of said second level cache,
said controller being operative upon receiving an I/O write request to:
search said second level cache for a cache line having related data entry;
upon identifying a related data entry in an identified cache line, determining if new data of the I/O write request overlaps existing data;
upon determining the new data does not overlap existing data, write said new data to a non-valid portion of said identified cache line, wherein said non-valid portion of said identified cache line is pre-filled with known default values; and
calculate and write updated parity for a RAID stripe of said second level cache including said identified cache line, wherein said updated parity is calculated free of reading said non-valid portion of said cache line.

14. The system of claim 13, wherein said controller writes cache lines to said SSDs, wherein each cache line is stored within a single data segment of said RAID stripe on one of said plurality of SSDs.

15. The system of claim 14, said controller writes cache lines having size substantially equal to a size of a single data segment of said RAID stripe.

16. The system of claim 13, wherein said controller is further operative to maintaining data identifying valid and invalid portions of cache lines stored in said second level cache.

17. The system of claim 13, wherein said controller is further operative to, upon initially writing a cache line to a RAID stripe of said second level cache, fill non-valid portions of said cache line with said default values.

18. The system of claim 17, wherein said controller is further operative to store plurality of cache lines to a matching plurality of data segments of a RAID stripe in said second level cache, wherein non-valid portions of each cache line are filled with default values and initially writing said plurality of cache lines comprises performing a full stripe write.

19. The system of claim 18, wherein said second level cache comprises a plurality of RAID sets, each RAID set including a plurality of SSDs.

20. The system of claim 19, wherein a total data transfer rate of said plurality of RAID sets is substantially equal to a data transfer rate of said controller.

21. The storage system of claim 13, wherein the controller is further operative to
de-allocate the memory blocks within the controller primary cache upon writing said new data to the second level cache.

22. A storage medium having instructions stored thereon which, when executed by a processor of a storage controller operatively connected a plurality of storage devices configured as one of more logical units and operatively connected to a plurality of solid state drives (SSDs) forming a second level cache in a parity RAID configuration, cause the processor to perform actions comprising:
storing a I/O write request to a set of allocated storage blocks in a primary cache memory of the storage controller, wherein the I/O write request addresses a storage location for data within the storage devices;
identifying a related address in a cache line of said second level cache, wherein said cache line is stored in a RAID stripe of said second level cache;
identifying a cache storage location in said cache line for said I/O write request as non-valid, wherein said non-valid portion of said cache line is filled with known default values,
calculating an updated parity for said RAID stripe of said second level cache including said cache line based on said new data and said known default values, wherein said updated parity is calculated free of reading said non-valid portion of said cache line;
writing said new data to said non-valid portion of said cache line in said RAID stripe of said second level cache and writing said updated parity to said RAID stripe; and
de-allocating the set of storage blocks in the primary cache of the controller upon completing the transfer of the new data of the I/O write request to the second level cache.

23. The storage medium of claim 22, further comprising instructions for changing an identification of said non-valid portion of said cache line to valid after writing said new data to said non-valid portion of said cache line.

24. The storage medium of claim 23, further comprising instructions for, upon initially writing said cache line to said RAID stripe, filling non-valid portions of said cache line with said default values.

25. The storage medium of claim 24, further comprising instructions for storing plurality of cache lines to a matching plurality of data segments of said RAID stripe, wherein non-valid portions of each cache line are filled with default values and initially writing said plurality of cache lines comprises performing a full stripe write.
